(19) United States
(12) Patent Application Publication
(10) Pub. No.: US 2004/0107447 A1
(43) Pub. Date: Jun. 3, 2004

(54) Information processing terminal and recorder/player

(76) Inventors: Makoto Katagishi, Chigasaki (JP); Taku Takaki, Fujisawa (JP); Osamu Hasegawa, Mito (JP)

Correspondence Address: MCDERMOTT, WILL & EMERY, 600 13th Street, N.W., Washington, DC, 20005-3096, US

(21) Appl. No.: 10/618,854

(22) Filed: Jul. 15, 2003

(30) Foreign Application Priority Data
Jul. 15, 2002 (JP) 2002-204995

(51) Int. Cl. H04N 7/16; H04N 11/00; H04N 7/00

(52) U.S. Cl. 725/135; 725/136; 348/460; 348/461

(57) ABSTRACT

Disclosed is an information processing terminal that is capable of receiving television and other broadcasts and providing increased user-friendliness. The information processing terminal, which is capable of communicating with another device, comprising a broadcast receiver which receives a broadcast signal that contains program identification information for specifying a program and/or program scene identification information for specifying a scene of the program and the video information of the program; a display which outputs the broadcast signal that is received by the broadcast receiver; and a storage which extracts the program identification information and/or program scene identification information from the broadcast signal received by the broadcast receiver and stores the extracted information while the display outputs the video information.

### BACKGROUND OF THE INVENTION

The present invention relates to an information processing terminal to be carried by a user to establish communication, a recorder/player capable of communicating with the information processing terminal, and a broadcast recorder/player system comprising the information processing terminal and the recorder/player. The information processing terminal to be provided by the present invention includes a cellular phone, PHS phone, PDA (Personal Digital Assistant), and PC (Personal Computer).

A remote setup system for performing various setup procedures at a remote terminal for a television broadcast receiver is disclosed by JP-A No. 57953/2000.

### SUMMARY OF THE INVENTION

Although the above public disclosure describes a terminal that provides remote control over video equipment recording settings and receiver setting changes, it does not consider the terminal's user-friendliness for receiving television broadcasts or the like.

Under the aforementioned circumstances, the present invention provides increased user-friendliness in receiving broadcasts with a terminal as set forth in the appended claims.

Other and further objects, features and advantages of the invention will appear more fully from the following description.

### BRIEF DESCRIPTION OF THE DRAWINGS

FIG. 1 is a system configuration diagram of a first embodiment.

FIG. 2 is a typical data structure diagram.

FIG. 3 is a flowchart illustrating a process that is performed by a first embodiment of a mobile terminal.

FIG. 4A shows a display example of the first embodiment of a mobile terminal.

FIG. 4B shows a display example of the first embodiment of a mobile terminal.

FIG. 5 is a flowchart exemplifying a process that is performed by a mobile terminal, a recorder/player, and a display device according to the first embodiment.

FIG. 6 shows a display example of the first embodiment of a mobile terminal.

FIG. 7 is a flowchart illustrating a process that is performed by a second embodiment.

FIG. 8 is a flowchart illustrating a process that is performed by a third embodiment.

FIG. 9 is a flowchart illustrating a process that is performed by the third embodiment.

FIG. 10 is a system configuration diagram exemplifying a fourth embodiment.

FIG. 11 is a system configuration diagram exemplifying a fifth embodiment.

FIG. 12 is a flowchart illustrating a process that is performed by a sixth embodiment.

FIG. 13A shows an example of a recorder/player according to a seventh embodiment.

FIG. 13B shows an example of a recorder/player according to the seventh embodiment.

FIG. 13C shows an example of a recorder/player according to the seventh embodiment.

### DETAILED DESCRIPTION OF THE PREFERRED EMBODIMENTS

A first embodiment will now be described. The first embodiment relates to a recorder/player system, which uses a mobile terminal capable of receiving television broadcasts. In the accompanying drawings, the same components or steps are identified by the same reference numerals.

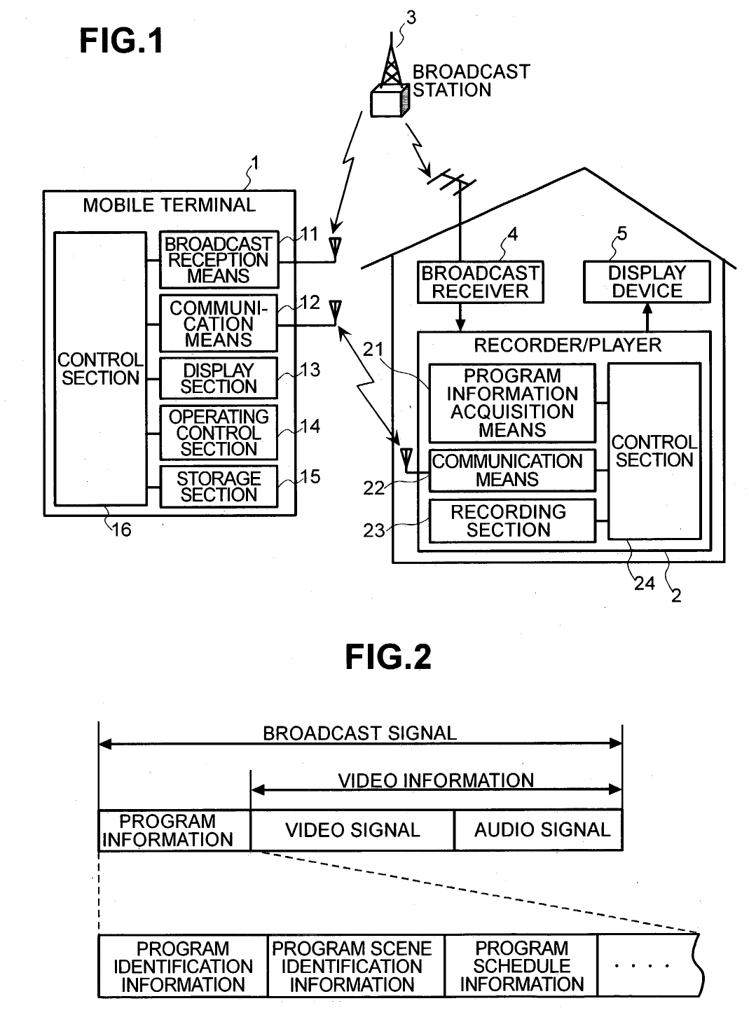

FIG. 1 shows a typical configuration of a recorder/player system according the present embodiment. The system comprises a mobile terminal 1 having a broadcast reception function, a recorder/player 2 which is capable of acquiring the information about broadcast programs, and a broadcast station 3 for broadcasting television images and the like.

First, the configuration of the mobile terminal 1 will be described. The mobile terminal 1 includes a broadcast reception means 11 for receiving broadcast signals broadcast by the broadcast station 3, a communication means 12 for communicating with an external device, a display section 13 for displaying broadcasts and the like, an operating control section 14, a storage section 15 for storing various data, and a control section 16 for controlling the above components. When a broadcast is received, the control section 16 exercises control so that a broadcast signal received by the broadcast reception means 11 appears on the display section 13.

As shown in FIG. 2, the broadcast signal is typically composed by adding broadcast information to the video information (video and audio signals) of a program broadcast by the broadcast station 3. The broadcast information is the information about a program broadcast by the broadcast station 3. More specifically, the broadcast information may be the information for identifying a program (hereinafter referred to as the “program identification information”), the information specifying a scene of a program (hereinafter referred to as the “program scene identification information”), the program schedule information which lists broadcast programs on various channels in tabular form, or a combination of these items of information.

The program identification information is the description of a program or other program information such as a program ID, program title, broadcast channel, broadcast time zone, and leading actor/actress name. Any information for identifying a program may be used as the program identification information. The program scene identification information may be the elapsed time from the beginning of a program, a section number of video information that is segmented into sections, or any other information that can identify a specific scene of a program.

Meanwhile, the recorder/player 2 includes a recording section 23 for recording broadcast signals entered from a broadcast receiver 4, a program information acquisition means 21 for acquiring the information about a program, a communication means 22 for communicating with an external device, and a control section 24 for controlling the above components. The output of video information recorded in the recording section 23 is forwarded to a display device 5 by the control section 24 so that the recorded video information appears on the display device 5. The communication means 12, 22 are used so that the mobile terminal 1 and recorder/player 2 communicate with each other directly or via a network. More specifically, the communication means 12, 22 may be an infrared communication port, wireless LAN system (ARIB STD-T66), or other device that can establish a direct wireless communication link with an external device. These communication means make it possible to exchange information without having to make a wired connection between devices. As a result, an increased degree of freedom is provided in usage site selection.

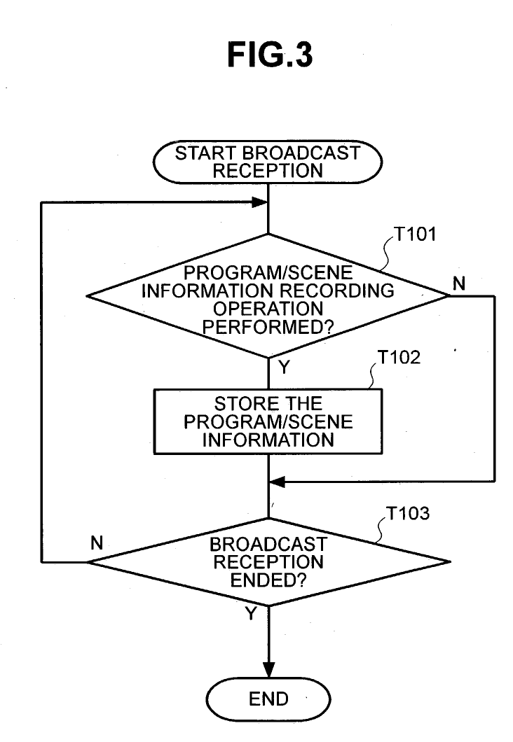

The process for recording program information while a broadcast is viewed with the mobile terminal 1 will now be described with reference to FIG. 3. When a recording request is entered via the operating control section 14 while a broadcast is being received (T101), a recording request signal enters the control section 16. Upon receipt of the recording request signal, the control section 16 extracts the information about a currently received broadcast program from a broadcast signal, stores it in the storage section 15, and stores the video information of the currently received broadcast program in the storage section 15 (T102). When the operating control section 14 issues a broadcast reception termination instruction, a broadcast reception termination signal enters the control section 16. The control section 16 then performs a broadcast reception termination process (T103).

In step T102 shown in FIG. 3, the storage section 15 in the mobile terminal 1 stores not only the program information but also the whole or part of video information of a currently received broadcast program as history information. This ensures that the contents of the stored program can be reconfirmed through the use of either program information or video information. In the process for recording the video information of a program, the control section 16 may alternatively cause the storage section 15 to store the video information during the interval between the instant at which a recording request signal input is received and the instant at which a recording termination instruction signal entered via the operating control section 14 is received. As another alternative, the control section 16 may exercise control so that the video information of a currently viewed program is extracted and stored in the storage section 15 in accordance with predefined reference data stored in the storage section 15.

The reference data is either recording time data (e.g., 1 second) or recording information quality data (e.g., 1 megabyte). The recording time data specifies the length of video information recording time after the reception of a recording request signal. The recording information quantity data specifies the amount of video information to be recorded. The control section 16 references the above reference data stored in the storage section 15 and performs a process so as to store a program's video information in the storage section 15.

For increased user-friendliness, it goes without saying that an alternative configuration may be formed so as to let a user define the above reference data. The storage section 15 stores user-defined reference data. When a recording request is entered via the operating control section 14 while a program is being viewed, the control section 16 receives a storage request signal, and exercises control so as to extract the video information of the currently viewed program in accordance with the reference data stored in the storage section 15 and store the extracted video information in the storage section 15. When a replay instruction is entered via the operating control section 14, a replay instruction signal enters the control section 16. Upon receipt of the replay instruction signal, the control section 16 replays the video information stored in the storage section. In the manner described above, the mobile terminal 1 replays the video information that is stored in the storage section 15. This replay operation is called a “terminal replay”. On the other hand, the operation performed as described later to replay the video information stored in the recording section 23 of the recorder/player 2 is simply referred to as a “replay”.

Thanks to the above features, the user can remember the contents of a stored program by referring to the video information as well as the program information. Therefore, the user can properly remember the contents of a casually recorded program during a brief interval such a break between successive meetings. Further, enhanced user-friendliness is provided because the user can define the reference data for specific video information that he/she records.

Upon receipt of a recording request signal after recording request input via the operating control section 14, the control section 16 exercises control so that the display section 13 opens a setup or like screen for setting up the above reference data. The screen then allows the user to define the length of video information recording time or enter some other setting as needed. This further enhances user-friendliness.

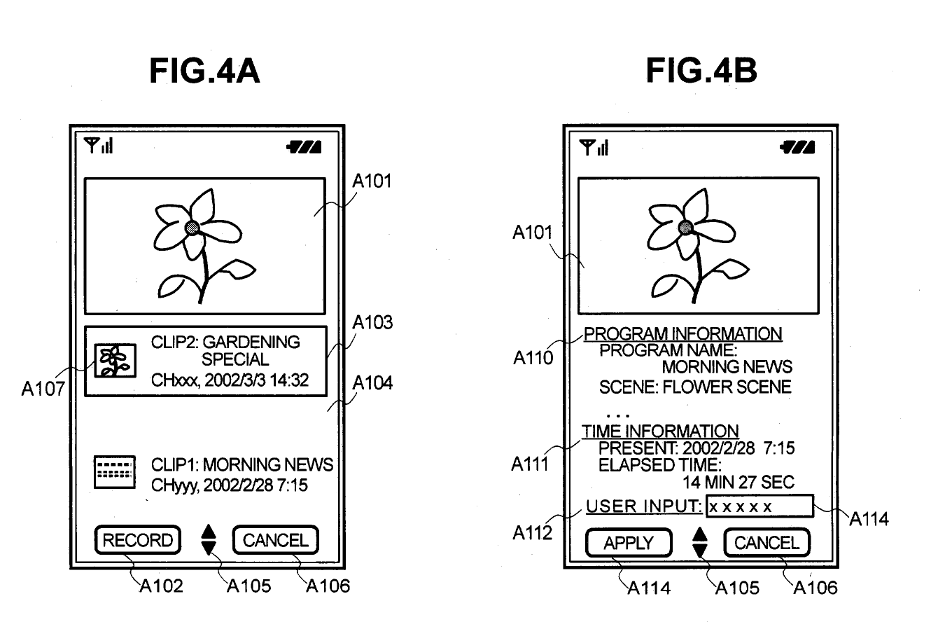

FIG. 4A shows an example of information that appears on the display section 13 of the mobile terminal 1 when it is used for recording program information or the like. The reference numeral A101 indicates video information that appears on the display section 13 while a program is being viewed. When a “recording” procedure (A102) is performed at the operating control section 15, the storage section 15 stores program information. As indicated by the reference numerals A103 and A104, the stored program information includes a clip number, program title, recording date/time, and channel. This information is displayed together with program identification image information (A107), which is created from the program video information stored in step T102 for the purpose of easily identifying the contents of a program. The user can make an information selection by using a scrolling feature (A105) on the operating control section 15. The user can also cancel (A106) stored program information and program identification image information.

Enhanced user-friendliness is provided because the user can set up and store program information while viewing a program. Further, since the display section 13 displays program identification image information together with program information, the user can easily identify the contents of a recorded program.

In the above example, a program title and other program information appear on the display in accordance with recorded program information. However, an alternative configuration may be employed so as to allow the user to change the program title or other program information as desired. FIG. 4B shows an example of information that appears on the display when such an alternative configuration is employed. The control section 16 extracts the program identification information such as a program ID, program scene identification information about a scene (A113), and other program information from a broadcast signal broadcast by the broadcast station 3, and displays them (A110). The current viewing time and the elapsed time from the start of a program may also be displayed (A111). The user then enters a desired title by pressing keys on the operating control section 14. To save the bother of keying in a title in this instance, the user can be allowed to copy the program information displayed in section A110 and paste it into a title input field. When the user performs the above title input procedure in relation to a display screen on which program information is displayed, the user can enter a title or other information with increased ease while viewing displayed program information.

Further, the employed configuration is such that on-screen program information can be scrolled up and down (A105). However, an alternative configuration may be employed so as to display program information in compact form using icons or the like. The use of such an alternative configuration increases the amount of information displayed on a single screen and permits the user to readily identify the contents of recordings even when the display section 13 of the mobile terminal is small.

In the above example, the video information (video and audio signals) of a program is recorded in addition to program information in order to facilitate the identification of a program. However, an alternative configuration may be adopted so as to record a program's video signal (still-picture information) only or audio signal only or record program information only without recording a program's video information. The use of such an alternative configuration contributes to reducing the storage size.

A program's video information can be recorded in various manners in addition to the manner described in conjunction with the present embodiment. An alternative configuration may be employed so as to offer a choice between still-picture recording and motion-picture recording, offer a storage format option (JPEG, GIF, etc.) for still-picture recording, and permits the user to make motion-picture recordings in accordance with predefined reference data or customize the reference data for motion-picture recording. The use of such an alternative configuration allows the user to select a recording manner that suits his/her preference when he/she records a program's video information, thereby further enhancing user-friendliness.

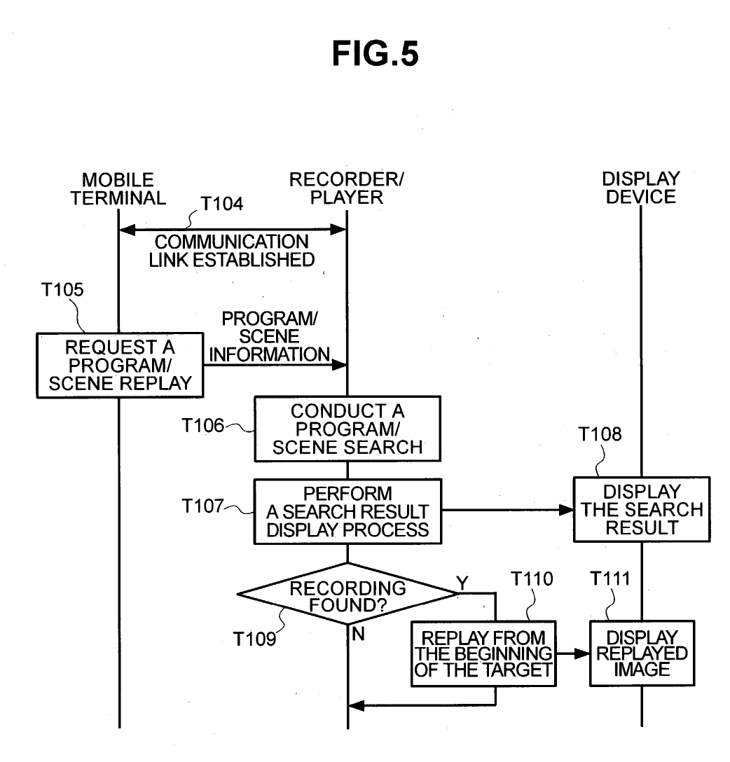

The operation performed to replay a program from its beginning or a certain intermediate scene on the display device 5 connected to the recorder/player 2 in accordance with program information and other information stored in the mobile terminal 1 will now be described. For the purposes of this description, it will be assumed that a user of the mobile terminal 1 operates the terminal at a location near the recorder/player 2. The process performed by the individual system components will be described with reference to FIG. 5. When the user performs an input procedure using-the operating control section 14 of the mobile terminal 1, communication means 12 of the mobile terminal 1 establishes a communication link with communication means 22 of the recorder/player 2. After the communication link is established, the program information stored in the storage section 15 of the mobile terminal 1, such as program identification information and/or program scene identification information, is transmitted to the recorder/player 2 automatically or in response to a certain user operation (T105).

It is assumed in the present embodiment that the broadcast signals (program information, video signal, and audio signal) received by the broadcast receiver 4 are prerecorded in the recording section 23 of the recorder/player 2 in accordance with the user's taste or needs.

Upon receipt of program information from the mobile terminal 1, the recorder/player 2 performs a process to compare the received program information against the program information stored in the recording section 23 (T106), conduct a search to check whether the matching program or the matching scene of a program is recorded, and display the result on the display device 5 (T108). When the search result indicates that the associated information recording is found, the recorder/player 2 performs a process to replay the matching program from its beginning or an intermediate scene (T110 and T111). If the search result indicates that no associated information recording is found, the recorder/player 2 does not perform a replay process.

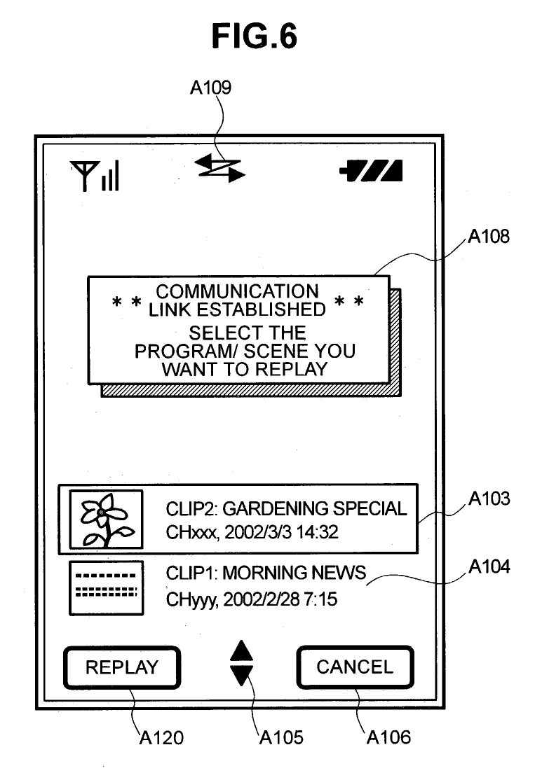

FIG. 6 shows an example of information that the display section, 13 of the mobile terminal 1 displays in the above sequence. This figure exemplifies a situation where the user is prompted to select a replay target after a communication link with the recorder/player 2 is established (T105). To let the user visually confirm the establishment of a communication link, indications A108 and A109 appear on the display. The user can choose a replay target by using a scrolling feature (A105) on the operating control section 15. When the operating control section 15 is operated to select a replay function (A120), the selected program information is transmitted to the recorder/player 2.

If, for instance, the user records into the mobile terminal the program information about a program viewed within a free time period during the user's move, and intends to replay the program stored in the recorder/player 2 installed on the user's premises when the user comes home, the above feature saves the user the bother of searching for the program by checking many programs stored in the recorder/player 2. The user can readily locate and view the program by issuing a replay instruction with operating control A120 and performing some other simple procedure. Therefore, enhanced user-friendliness is provided.

After a replay instruction is issued with operating control A120 shown in FIG. 6, the user may alternatively be offered a choice between performing a terminal replay operation at the mobile terminal 1 and establishing a communication link with the recorder/player 2 to issue a replay request to the recorder/player 2. Another alternative configuration may be employed so as to let the mobile terminal 1 automatically perform a terminal replay operation when a replay instruction is issued by operating control A120 shown in FIG. 6 and then prompt the user to specify whether or not to issue a replay request to the recorder/player 2. Thanks to this feature, the user can determine whether or not to issue a replay request after properly remembering the contents of a program recorded in the mobile terminal 1. This decreases the possibility of replaying an unwanted program.

A second embodiment of the present invention will now be described. The first embodiment relates to a case where a program recorded in the mobile terminal 1 is stored in the recorder/player 2 beforehand. In reality, however, there are cases where such a program is not stored in the recorder/player 2 beforehand. The second embodiment relates to a case where the mobile terminal 1 issues a program recording instruction is to the recorder/player 2.

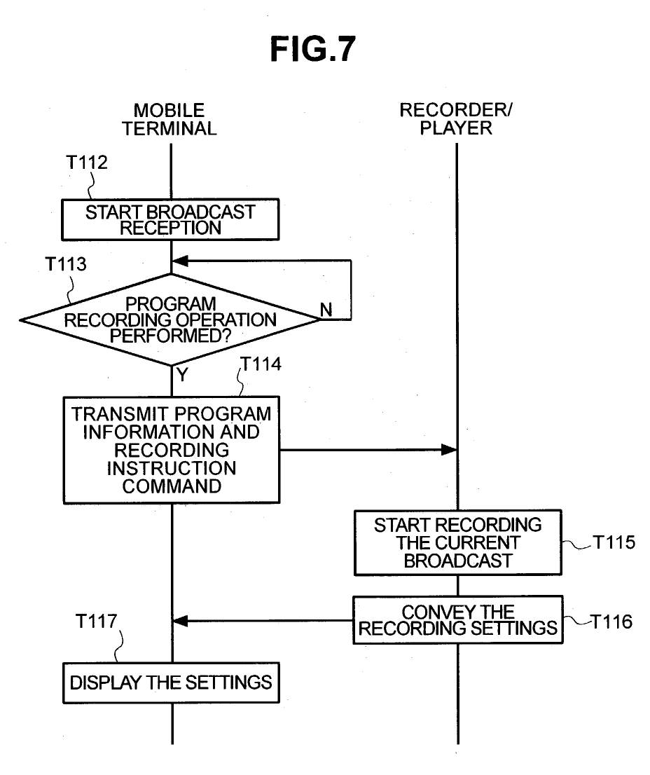

FIG. 7 shows an example of a process that is performed by a broadcast recording/replay system according to the present embodiment. When a recording request is entered via the operating control section 14 while the mobile terminal 1 is receiving a broadcast (T112 and T113), a recording request signal enters the control section 16. As indicated in step T102 shown in FIG. 3, the control section 16 stores program information and program identification image information, which are contained in a currently received broadcast signal, into the storage section 15 while extracting the program information from the currently received broadcast signal. The control section 16 then transmits a recording instruction command to the recorder/player 2 for the purpose of recording the program information and the associated program (T114). Upon receipt of the recording instruction command from the mobile terminal 1, the control section 24 of the recorder/player 2 starts recording the program in accordance with the recording instruction command and program information (T115). In accordance with the program information, the control section 24 of the recorder/player 2 performs a process so as to automatically terminate a recording operation at the end of the program. This saves the user the bother of issuing a recording termination instruction.

After starting a recording operation, the recorder/player 2 transmits a recording setup signal for the program to the mobile terminal 1 (T116). Upon receipt of the recording setup signal, the mobile terminal 1 causes the display section 15 to display the recording setup information about the program such as the start of recording, the information about the program designated by the recording request, and the remaining time available for recording (T117).

In a manner described above, recording setup can be completed for the recorder/player 2 installed on the user's premises while the user views a program on the mobile terminal 1. Thanks to the above feature, the recorder/player 2 never fails to contain the recording information about the program when the mobile terminal 1 is used to request the recorder/player 2 to replay the program.

Further, the user does not have to worry whether a recording operation is properly performed because the user is notified of the contents of recording setup. Furthermore, the user issues a recording instruction to the recorder/player 2 using program information that is recorded in the mobile terminal 1 during broadcast reception. This feature reduces the number of input steps the user has to perform, thereby providing increased user-friendliness.

An alternative configuration may be formed so that the recorder/player 2 transmits a recording setup signal for the program to the mobile terminal 1 prior to the start of recording, and that the mobile terminal 1, upon receipt of the recording setup signal, displays the recording setup information about the program on the display section 15 and prompts the user to specify whether or not to start recording the program. This alternative configuration enables the user to confirm the recording setup information prior to the start of recording and then determine whether or not to start recording. When this alternative configuration is employed, the user can change his/her mind after issuing a recording instruction and cancel the issued recording instruction. This results in an increase in user-friendliness.

When the user of the mobile terminal 1 issues an instruction for canceling a recording operation, the recording process of the recorder/player 2 may alternatively be brought to a forced termination. In this instance, the control section 24 brings a program recording operation to a forced termination in accordance with a recording termination instruction signal received from the mobile terminal 1 and without regard to a recording instruction command. This enables the user to stop recording at any time, thereby increasing user-friendliness.

Recording instructions can be issued in various manners. The mobile terminal 1, which is carried by the user, may transmit a recording instruction command to the recorder/player 2 so as to specify the length of recording time or the amount of information to be recorded or specify the exact recording start time and end time. This allows the user to specify the period of time during which program recordings should be made, thereby providing increased user-friendliness.

A third embodiment will now be described. In the second embodiment, the recorder/player 2 cannot start recording at the beginning of a program because it starts a recording operation when the recording of a currently viewed program is requested. To have the recorder/player 2 start recording at the beginning of a program, the third embodiment conducts a search to check whether the program is to be rebroadcast at an early date (e.g., within a month). If the search reveals a planned rebroadcast, the third embodiment allows the user to schedule a recording of the rebroadcast.

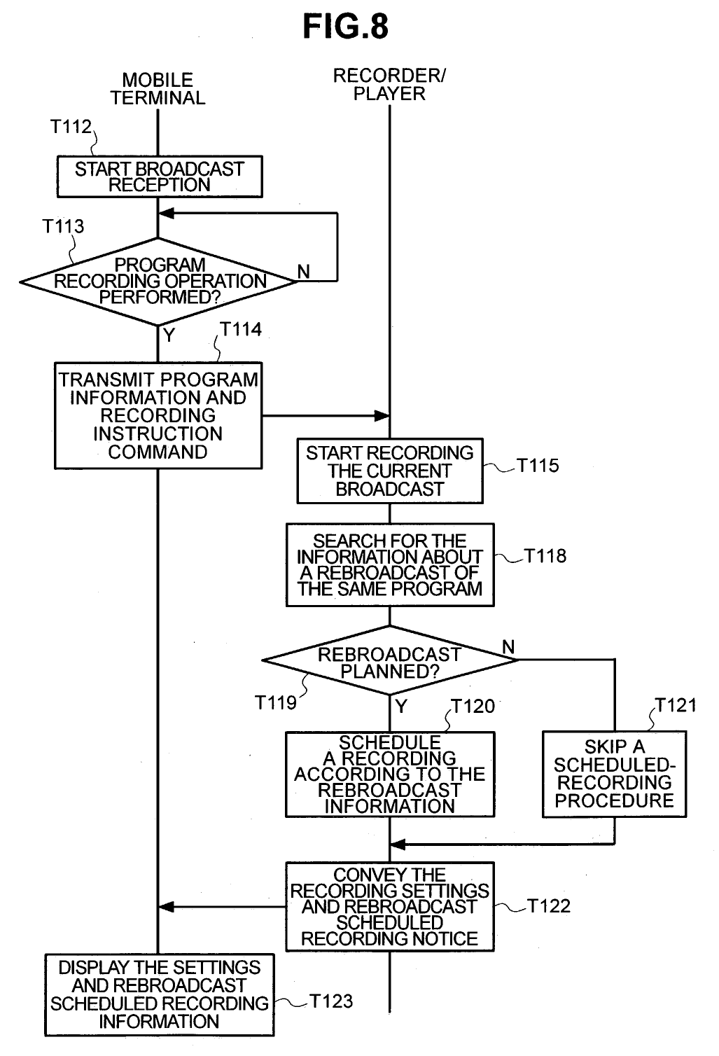

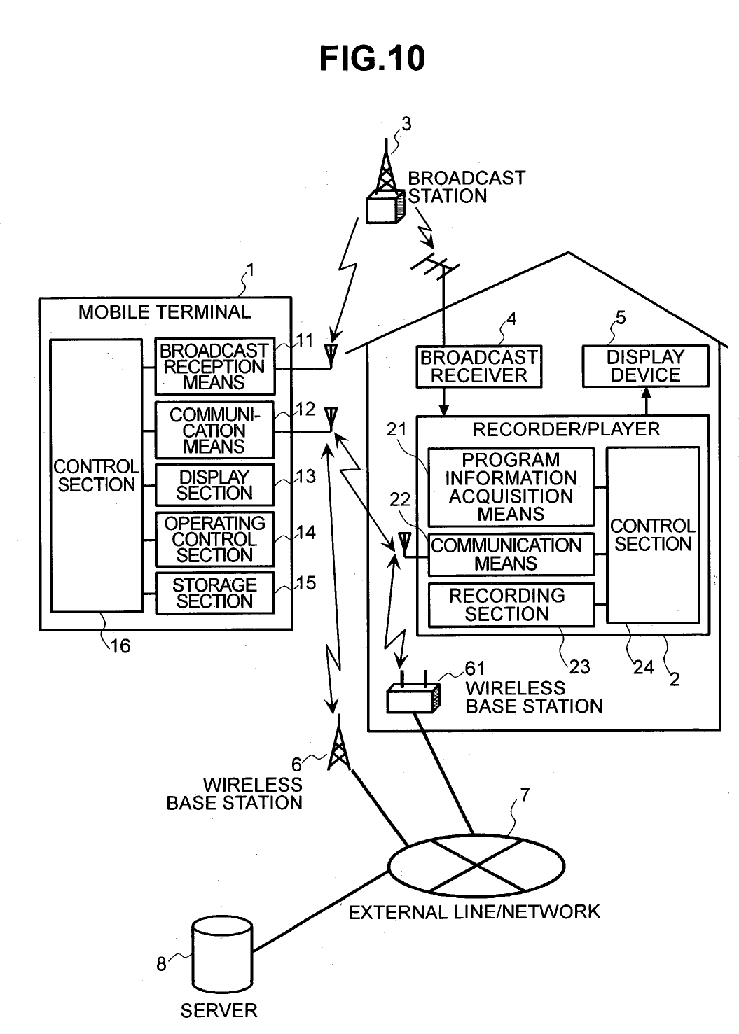

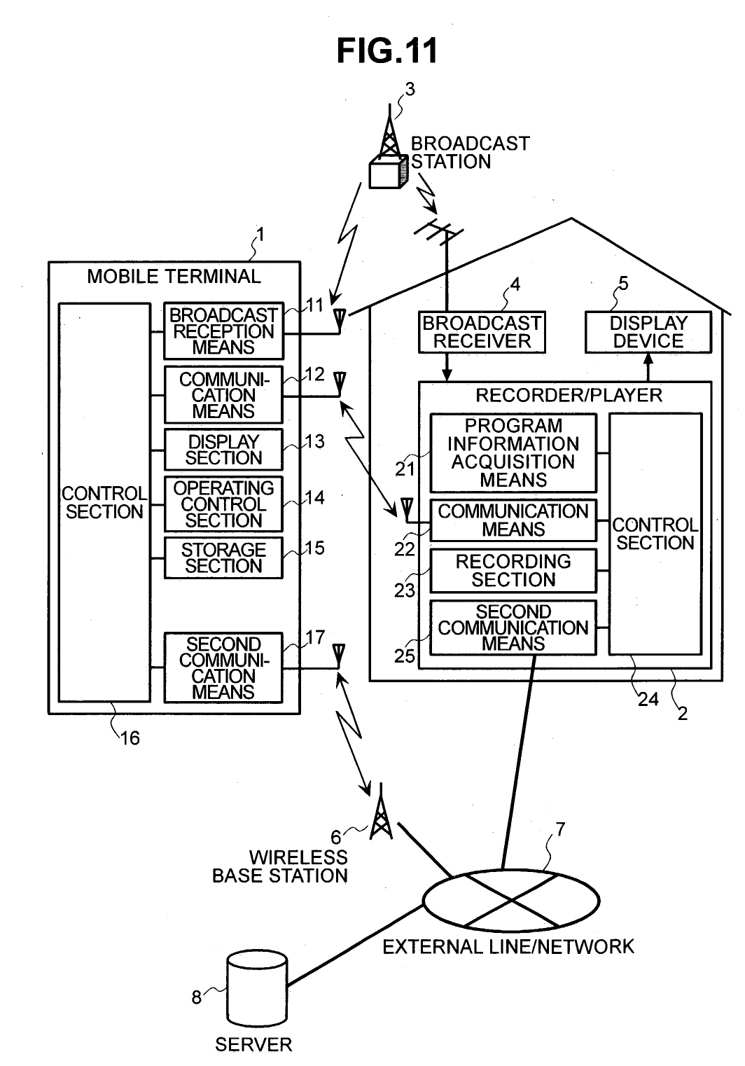

FIG. 8 illustrates the process performed by the components of a system according to the present embodiment. Processing steps T112 to T115 are identical with steps T112 to T115 in FIG. 7. The control section 24 of the recorder/player 2, which has started a recording operation, conducts a search in accordance with the program information about a program designated by a recording request (e.g., a program ID or program listings to be broadcast at an early date) to check whether the program is to be rebroadcast at an early date (T118). As a search means enabling the control section 24 to search for the rebroadcast information, means for accessing an external server 8 is additionally provided as shown in FIGS. 10 and 11, and the program information is transmitted to the external server 8. Upon receipt of the program information, the external server 8 conducts a search to check whether the program is to be rebroadcast, and then sends the search result to the recorder/player 2. This feature not only lessens the processing load on the recorder/player 2 and reduces the power consumption-but also enables the user to quickly obtain the search result from the external server. As the program information, the program information received from a broadcast station or the like may alternatively be used.

If the search result indicates that the program is to be rebroadcast, the control section 24 performs setup for a scheduled recording in accordance with the rebroadcast information (T120). If the program is not to be rebroadcast, the control section 24 does not perform setup for a scheduled recording (T121). When the scheduled recording is set up, the recorder/player 2 conveys a recording setup signal and rebroadcast scheduled recording signal for the target program to the mobile terminal 1 (T122). Upon receipt of the recording setup signal and rebroadcast scheduled recording signal, the mobile terminal 1 stores the recording setup signal and rebroadcast scheduled recording signal in the storage section 15 and causes the display section 15 to display the recording settings, rebroadcast scheduled recording settings, and other relevant information about the program (T123). If no associated rebroadcast plan is found, the display section 15 indicates it. When replaying the video information that is recorded from a rebroadcast, the control section 16 of the mobile terminal 1 handles the rebroadcast scheduled recording signal stored in the storage section 15 as the program information and transmits it to the recorder/player 2 as indicated in step T105 in FIG. 5. Upon receipt of the rebroadcast scheduled recording signal, the recorder/player 2 causes the display device 5 to display the rebroadcast video information stored in the recording section 23.

A rebroadcast can be searched for and scheduled for recording by performing a simple procedure as described above. This feature is very useful because it enables the user to view a program from its beginning. The feature also notifies the user whether a program designated by a recording request is to be rebroadcast.

As is the case with the second embodiment, an alternative configuration may be employed so that the recorder/player 2 conveys the recording setup signal for the program to the mobile terminal 1 prior to the start of recording, and that the mobile terminal 1, upon receipt of the recording setup signal, causes the display section 15 to display the recording setup information and rebroadcast scheduled recording information about the program and prompts the user to choose the option of starting a recording operation immediately, scheduling the recording of a rebroadcast, or initiating no recording operation. This enables the user to view the recording setup information, rebroadcast scheduled recording information, or other relevant information before the start of recording and decide whether or not to record the program. For example, the user can choose to not record the program because it is to be rebroadcast at an early date or to record the program because it is not to be rebroadcast at an early date. In this manner, the user can examine the information about a program rebroadcast and then decide whether or not to record a currently viewed program. This results in an increase in user-friendliness.

The present embodiment has been described as causing the recorder/player 2 to search for the information about a rebroadcast. However, the mobile terminal 1 may alternatively search for the information about a rebroadcast and transmit the search result to the recorder/player 2.

When a rebroadcast is recorded in accordance with the present embodiment, the video information recorded after recording request issuance (T113) (hereinafter referred to as the post-recording-request video information) and the video information recorded from the beginning of a rebroadcast program (hereinafter referred to as the rebroadcast video information) both exist in the recorder/player 2. In this instance, the program information relates to the post-recording-request video information and does not relate to the rebroadcast video information. Therefore, the user cannot view the rebroadcast using the program information that is obtained upon a recording request (T113).

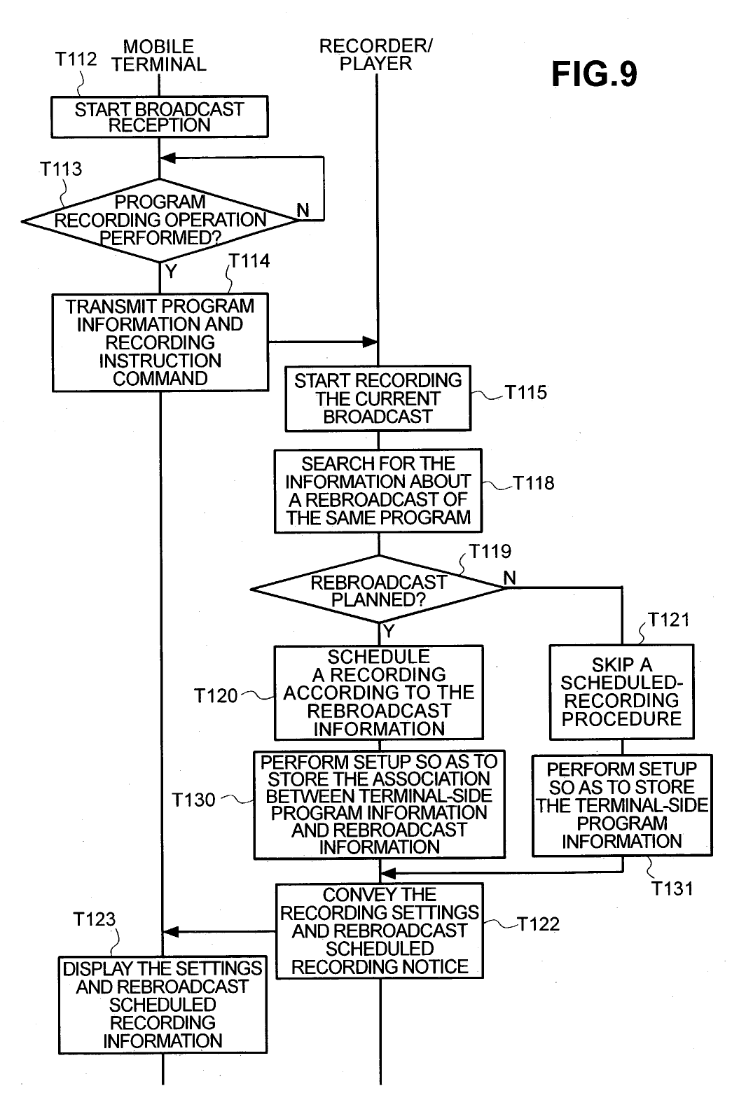

As indicated in FIG. 9 (T130 and T131), when the program is to be rebroadcast at an early date, its recording is scheduled in accordance with the information about such a rebroadcast (T120), and the control section 24 of the recorder/player 2 performs setup so as to store the association between the program information, which is transmitted from the mobile terminal 1, and the rebroadcast information (T130). If the program is not to be rebroadcast at an early date, on the other hand, the control section 24 of the recorder/player 2 does not schedule its recording (T121) and performs setup so as to store only the program information transmitted from the mobile terminal (T131).

When the post-recording-request video information and rebroadcast video information both exist in the recorder/player 2, their association is stored as described above. Therefore, even if an instruction for replaying the post-recording-request video information is transmitted, the recorder/player 2 can readily search for the rebroadcast video information and display it on the display device 5. This enables the user to easily replay the rebroadcast video information using the program information stored at the time of recording request issuance.

FIG. 9 shows an example of a process that is performed by a broadcast recording/replay system according to the present embodiment. Steps other than T130 and T131 will not be detailed herein because they are the same as indicated in the process shown in FIG. 8. An alternative configuration may be formed so as to selectively replay the post-recording-request video information and rebroadcast video information. In such an alternative configuration, the user can choose to view a program after recording request issuance or view a rebroadcast from its beginning. This results in an increase in user-friendliness.

A fourth embodiment will now be described with reference to FIG. 10. FIG. 10 shows an example of a broadcast recording/replay system configuration according to the forth embodiment. In the present embodiment, the communication means 12, 22 of the mobile terminal 1 and recorder/player 2 can establish a communication link via an external line or network. If, for instance, the aforementioned second-generation low-power data communication system/wireless LAN system (ARIB STD-T66) is used as a communication transmission path, wireless base stations 61, 62 called access points are installed outdoors or on the user's premises and can be interconnected via an external network 7 (Internet). If the mobile terminal 1 and recorder/player 2 are on the user's premises, direct communication can be established. If the user moves outdoors while carrying the mobile terminal 1, communication can be established via the external network. Therefore, the present embodiment is effective in issuing a recording request from the mobile terminal 1 to the recorder/player 2. Further, an external server 8 can be accessed to acquire program-related information other than information extractable from a broadcast signal. As a result, enhanced user-friendliness is provided.

A fifth embodiment will now be described with reference to FIG. 11. FIG. 11 shows an example of a broadcast recording/replay system configuration according to the fifth embodiment. In the present embodiment, the mobile terminal 1 and recorder/player 2 are equipped with second communication means 17, 25. Unlike the fourth embodiment, the present embodiment uses communication means 12, 22 when the mobile terminal 1 and recorder/player 2 directly communicate with each other, and uses the second communication means 17, 25 when they communicate with each other via the external network 7. The present embodiment is also effective in issuing a recording request from the mobile terminal 1 to the recorder/player 2. Further, the external server 8 can be accessed to acquire program-related information other than information extractable from a broadcast signal. Therefore, enhanced user-friendliness results.

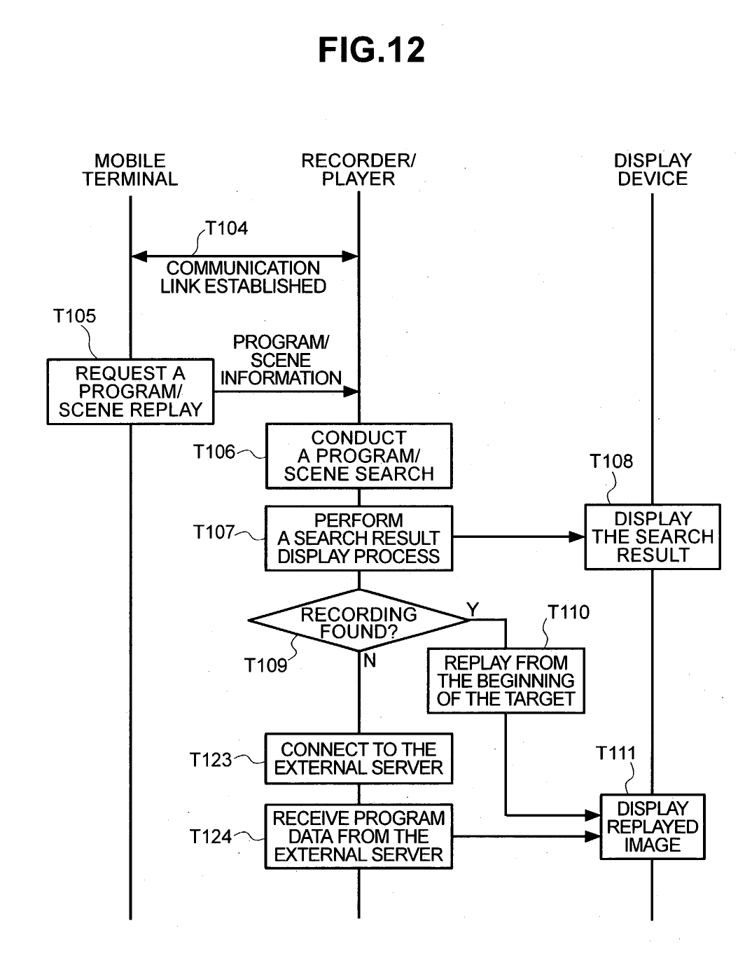

A sixth embodiment will now be described with reference to FIG. 12. FIG. 12 shows an example of a broadcast recording/replay system configuration according to the sixth embodiment. The present embodiment relates to a process that is performed when the recorder/player 2 does not have a recording log in situations where the mobile terminal 1 issues a replay request to the recorder/player 2 in the first embodiment. When the recorder/player 2 receives the information specifying a program or a certain scene of a program from the mobile terminal 1, the control section 24 conducts a search on the information stored in the recording section 23 (T106) and performs a process so as to display the search result on the display device 5 (T108). When the search result indicates that the information about a target recording exists, the recorder/player 2 performs a process so as to replay the specified program or scene from its beginning (T110 and T111). If the search result indicates that there is no information about the target recording, the recorder/player 2 connects to the external server 8 shown in FIG. 10 or 11 and makes a request for acquiring the program-related information about the program. Upon receipt of the program-related information acquisition request from the recorder/player 2, the external server 8 sends the program-related information to the recorder/player 2. The program-related information may be, for example, the recorded broadcast data, the information about a program rebroadcast, the information about a program introduction home page, the information about the cast, and the synopsis of a program. After acquiring the program-related information from the external server 8, the recorder/player 2 stores the program-related information in the recording section 23 and then opens a replay screen on the display device 5. In this case, increased user-friendliness is provided because the user can acquire various items of above-mentioned program-related information from the server 8 without conducting a search with the recorder/player 2. The recorder/player 2 may alternatively replay a program in a streaming manner by sequentially displaying recorded broadcast data in a replay screen on the display device 5 while receiving recorded broadcast data from the server 8. Even if the recorder/player 2 does not have a recording log, the present embodiment enables the recorder/player 2 to acquire various items of program-related information from the external server 8 in compliance with a replay request from the mobile terminal 1 and supply them to the user.

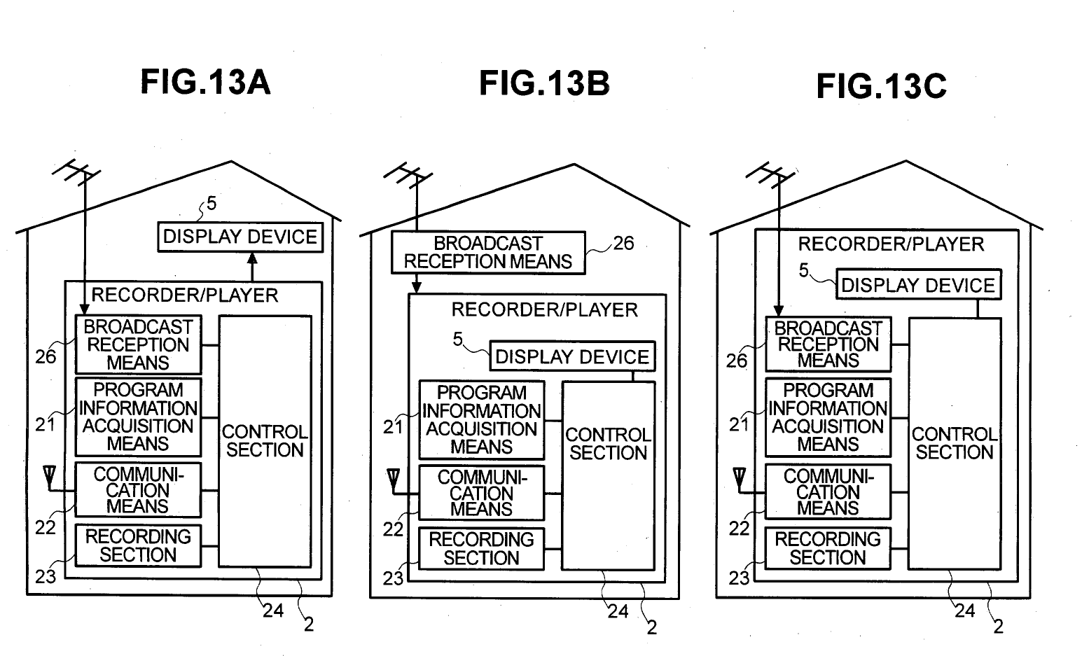

In the foregoing embodiments, the broadcast receiver 4 or display device 5 is positioned outside the recorder/player 2. However, the present invention is not limited to such embodiments. Alternatively, either the broadcast receiver 4 or the display device 5 may be positioned inside the recorder/player 2 as indicated in FIGS. 13A and 13B. As another alternative, the broadcast receiver 4, and display device 5 may be both positioned inside the recorder/player 2 as indicated in FIG. 13C.

Although the first embodiment records the video information of a target program, the resulting video information recording may alternatively be attached to e-mail for transmission or rendered editable or otherwise processable. A program's video information recording can then be effectively utilized by another user (at another mobile terminal). This results in an increase in user-friendliness.

In some cases, the broadcast station 3 for transmitting broadcast signals or an agent who broadcasts broadcast signals in place of the broadcast station may be troubled if the video information is readily replayed or duplicated. To avoid such a trouble, restriction information for imposing limitations on video information replay or duplication may be additionally entered in a data format shown in FIG. 2 and transmitted. When video information with restriction information is received at the mobile terminal, it can be replayed or duplicated in compliance with the restriction information. This prevents individual users from freely replaying or duplicating the video information. As a result, broadcasting corporations and their agents can broadcast video information without having to worry about unauthorized use of their broadcasts. The restriction information may be, for example, the information for thoroughly prohibiting the replay or duplication of video information and other broadcast contents, the information for permitting the replay or duplication of video information and other broadcast contents a predetermined number of times or for a predetermined period of time, the information for preventing video information and other broadcast contents from being attached to e-mail for forwarding to another terminal, or the information for permitting the free replay and duplication of video information and other broadcast contents.

While the present invention has been described in terms of preferred embodiments, it is to be understood that the invention is not limited to those preferred embodiments.

As described above, the present invention provides an increased degree of user-friendliness in situations where the terminal receives a broadcast itself.

The foregoing invention has been described in terms of preferred embodiments. However, those skilled, in the art will recognize that many variations of such embodiments exist. Such variations are intended to be within the scope of the present invention and the appended claims.

What is claimed is:

1. An information processing terminal capable of communicating with another device, comprising:
a broadcast receiver which receives a broadcast signal that contains program identification information for specifying a program and/or program scene identification information for specifying a scene of the program and the video information of the program;
a display which outputs the broadcast signal that is received by the broadcast receiver; and
a storage which extracts the program identification information and/or program scene identification information from the broadcast signal received by the broadcast receiver and stores the extracted information while the display outputs the video information.

2. The information processing terminal according to claim 1, further comprising a transmitter which transmits the program scene identification information stored by said storage when requesting the replay of video information stored in said another device.

3. The information processing terminal according to claim 1, further comprising a recording instruction section which instructs, while the video information is being output by said display, said another device to record said video information.

4. The information processing terminal according to claim 3, further comprising a transmitter which transmits the program identification information and/or said program scene identification information stored in said storage to said another device when said recording instruction section issues a recording instruction to said another device.

5. An information processing terminal capable of communicating with another device, comprising:
a receiver which receives a broadcast signal which at least contains the information about a program and the video or audio signal of the program;
a storage which stores the information about the program that is received by the receiver;
a transmitter which transmits to said another device the information about the program that is stored in the storage; and
a controller which exercises control, after the transmitter transmits the information about the program, so as to receive the information about recording a rebroadcast of the program and display the information about the recording of the rebroadcast.

6. An information processing terminal capable of communicating with another device, comprising:
a receiver which receives a broadcast signal which at least contains the information about a program and the video or audio signal of the program;
a storage which stores the information about the program that is received by the receiver;
a transmitter which transmits to said another device the information about the program that is stored in the storage; and
a recording instruction section which issues an instruction for recording the video information of the program; and
a selector which chooses, when requesting the replay of the video information stored in said another device, whether to replay the video information that is recorded from the instant at which a recording instruction is issued to the recording instruction section or to replay the video information from the beginning of the program.

7. The information processing terminal according to claim 1, further comprising a program-related information acquisition section which acquires the program-related information about said program, said program-related information acquisition section acquiring the program-related information when said another device does not store the video information of said program.

8. The information processing terminal according to claim 1, wherein choices can be made to transmit the information about a program that is stored in said storage to said another device either via an external server or directly

9. An information processing terminal, comprising:
a receiver which receives the information about a program and the video information of the program;
an instruction section which issues an instruction which stores at least either the information about the program or the video information of the program;
a storage which stores at least part of the video information of the program and the information about the program when a storage instruction is issued by the instruction section; and
a controller which exercises control so as to display the information about the program as well as at least part of the video information of the program that is stored in the storage.

10. The information processing terminal according to claim 9, wherein said controller exercises control so as to display, as the history information about a program stored via said instruction section, the information about said program as well as at least part of the video information of said program that is stored in said storage.

11. A recorder/player, comprising:
a broadcast receiver which receives a broadcast signal containing the information about a program and the video information of the program;
a storage which stores the information about the program and the video information of the program, which are received from the broadcast receiver;
a communicator which communicates with an external terminal; and
a controller which exercises control so as to conduct a search, when the information about the program that is stored in the external terminal is received from the communication section, to check whether the rebroadcast information about the program exists in a rebroadcast information database, which is stored beforehand in the storage, and schedule the recording of the rebroadcast of the program in accordance with rebroadcast information when the rebroadcast information is found to be available.

12. The recorder/player according to claim 11, wherein said controller exercises control, when the rebroadcast of said program is recorded by scheduled recording, so as to replay the rebroadcast, which is automatically recorded when the information about the program that is stored in said external terminal is received from the communication section.

13. An information processing terminal capable of communicating with another device, comprising:
a broadcast receiver which receives a broadcast signal containing the information about a program and the video information of the program;
a storage which extracts the information about a program from the broadcast signal received by the broadcast receiver, and storing the extracted information;
an output section which outputs the broadcast signal which is received by the broadcast receiver; and
a transmitter which transmits the information about the program to said another device while the output section outputs the video information.

14. An information processing terminal capable of communicating with another device, comprising:
a broadcast receive means for receiving a broadcast signal that contains program identification information for specifying a program and/or program scene identification information for specifying a scene of the program and the video information of the program;
a output means for outputting the broadcast signal that is received by the broadcast receiver; and
a storage means for extracting the program identification information and/or program scene identification information from the broadcast signal received by the broadcast receiver and storing the extracted information while the output means outputs the video information.
Disclosed is an information processing terminal that is capable of receiving television and other broadcasts and providing increased user-friendliness. The information processing terminal, which is capable of communicating with another device, comprising a broadcast receiver which receives a broadcast signal that contains program identification information for specifying a program and/or program scene identification information for specifying a scene of the program and the video information of the program; a display which outputs the broadcast signal that is received by the broadcast receiver; and a storage which extracts the program identification information and/or program scene identification information from the broadcast signal received by the broadcast receiver and stores the extracted information while the display outputs the video information.
